(19) United States
(12) Patent Application Publication
(10) Pub. No.: US 2008/0086865 A1
(43) Pub. Date: Apr. 17, 2008

(54) Spacer mounting mechanism, component mounting jig, and method for fabricating component having spacers

(75) Inventor: Shigenori Kuzuhara, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/652,476

(22) Filed: Jan. 12, 2007

(30) Foreign Application Priority Data
Sep. 29, 2006 (JP) 2006-268651

(51) Int. Cl. B23P 11/00

(52) U.S. Cl. 29/464; 29/559

(57) ABSTRACT

A spacer mounting mechanism for mounting a plurality of spacers to a product plate while holding the spacers in position includes a fixed plate; a movable plate which is movable relative to the fixed plate; fixed-side blocks which are formed on the fixed plate at positions corresponding to the spacers; and movable-side blocks which are formed on the movable plate so as to be paired with the respective fixed-side blocks. After the spacers are placed on the respective fixed-side blocks, the movable plate is moved in such a direction as to engage the spacers, thereby holding the spacers fixed between the respective fixed-side blocks and movable-side blocks. Such a spacer mounting mechanism is also called a component mounting jig. Also disclosed is a method for fabricating a component having spacers by mounting the spacers to a product plate using such a spacer mounting mechanism.

### BACKGROUND OF THE INVENTION

1. Field of the Invention

The present invention relates to a spacer mounting mechanism and component mounting jig for mounting a plurality of spacers to each individual product plate efficiently and in a short time while holding the spacers in position when assembling a stack structure of a plurality of product plates comprising printed board units, electronic appliance units, or the like; the invention also relates to a method for fabricating a component having spacers by mounting the spacers to a product plate using such a spacer mounting mechanism.

2. Description of the Related Art

Usually, in an electronic apparatus or a communication apparatus, a product-plate stack structure, constructed by stacking one on top of another a plurality of product plates comprising printed board units, electronic appliance units, or the like, is mounted within an apparatus cabinet. In this case, a plurality of spacers (for example, polygonal spacers) are mounted to each product plate so that the plurality of product plates can be installed by maintaining proper spacing from each other.

Here, to facilitate an understanding of the problem that occurs when mounting a plurality of spacers on a product plate in accordance with a prior art method, a procedure for mounting a plurality of spacers on a product plate according to the prior art will be described below by referring to the FIG. 1 mentioned later in the section of “BRIEF DESCRIPTION OF THE DRAWINGS.”

The procedure for mounting a plurality of spacers on a product plate in accordance with the prior art method is shown, for example, in a perspective view in FIG. 1. Here, the flow of the spacer mounting job practiced in the prior art when mounting a plurality of spacers on a given product plate is illustrated in schematic form in FIG. 1.

As shown in FIG. 1, when mounting a plurality of spacers (polygonal spacers in the illustrated example) SP to a product plate PP in accordance with the prior art method, the product plate PP is first held in a vertical position by a holder or the like and, with one spacer held in position by a box screwdriver BD which is used to hold each individual spacer SP, a mounting screw AS for that spacer is tightened by a Phillips screwdriver PD to mount the spacer in place. This spacer mounting job requires the use of two hands because the two screwdrivers, the box screwdriver BD and the Phillips screwdriver PD, have to be used simultaneously. Compared with a single-hand job, the two-hand job is complex and increases the degree of difficulty of the job. Furthermore, when mounting the plurality of spacers to the product plate PP, the two-hand job such as described above has to be repeated as many times as there are spacers (for example, when mounting 10 spacers to the product plate PP, the two-hand job has to be repeated 10 times). As a result, the time-wasting action of exchanging tools (the box screwdriver BD and the Phillips screwdriver PD) occurs as many times as there are spacers. This has led to the problem that the spacer mounting job for mounting the plurality of spacers to the product plate becomes difficult to accomplish efficiently and in a short time.

More specifically, the flow of the spacer mounting job practiced in the prior art involves the following steps (1) to (8).

(1) The product plate PP is set and held in position by a holder or the like.

(2) While holding one spacer with the box screwdriver BD, the spacer is held by one hand (that is, the spacer held by one hand is inserted in the box screwdriver BD held by the other hand).

(3) The Phillips driver is held by the hand opposite to the hand holding the box screwdriver BD.

(4) The mounting screw AS is fitted onto the Phillips screwdriver PD.

(5) The mounting screw AS fitted on the Phillips screwdriver PD is inserted in a hole of a spacer mounting portion SF.

(6) The spacer held in the box driver BD is placed against the mounting screw AS and screwed onto it.

(7) The mounting screw AS is tightened with a specified torque.

(8) The above steps (1) to (7) are repeated as many times as there are spacers.

For reference, patent documents 1 and 2 listed below are presented as prior art documents related to the spacer mounting job of the prior art described above.

(i) Patent document 1: Japanese Unexamined Patent Publication (Kokai) No. 9-92155

(ii) Patent document 2: Japanese Unexamined Patent Publication (Kokai) No. 2003-188558

Patent document 1 discloses the construction of a positioning jig which is used when mounting spacers by heating to the face plate or rear plate of an image forming apparatus that uses an electron source, wherein an assembly jig for holding the spacers in position is constructed from a set of a plurality of rectangular-shaped split plates arranged in parallel, each plate having spacer-inserting cutouts at predetermined positions on an longitudinal edge face of the plate, and wherein the width of the shorter side of each rectangular-shaped split plate is approximately equal to the spacing at which the corresponding spacers are to be mounted and each cutout is shaped so as to accommodate the corresponding spacer.

Patent document 2 discloses a structure for mounting a plurality of circuit packages in an apparatus cabinet, wherein spacers for mounting the circuit packages in the cabinet, by stacking them one spaced a prescribed distance apart from another, are not separately provided between the respective circuit packages, but are integrated into a single rod provided with spacing maintaining members for maintaining the spacing between the circuit packages, thereby significantly reducing the number of spacers while facilitating the mounting and removal of the circuit packages.

However, neither patent document 1 nor patent document 2 mentions any concrete technique for simplifying the spacer mounting job by performing the job of holding the plurality of spacers and the job of tightening the plurality of mounting screws separately from each other, while greatly reducing the number of times of exchanging tools such as screwdrivers, thereby eliminating time-wasting actions, by continuously performing the action of tightening the plurality of mounting screws by collectively holding the spacers in position. Accordingly, the technique disclosed in each of patent documents 1 and 2 involve the same problem as that described before in connection with the prior art spacer mounting job.

### SUMMARY OF THE INVENTION

The present invention has been devised in view of the above problem, and it is an object of the present invention to provide a spacer mounting mechanism and component mounting jig that can accomplish the spacer mounting job efficiently and in a short time by performing the job of holding the plurality of spacers and the job of tightening the plurality of mounting screws separately from each other, thereby simplifying the spacer mounting job for mounting the spacers to a product plate, and by continuously performing the action of tightening the plurality of mounting screws, etc., thereby greatly reducing the number of times of exchanging tools such as screwdrivers; the object of the invention also includes providing a method for fabricating a component having spacers.

To achieve the above object, according to a first aspect of the present invention, there is provided a spacer mounting mechanism (that is, a component mounting jig) for mounting spacers to a product plate, comprising a fixed plate; a movable plate which is movable relative to the fixed plate; fixed-side blocks which are formed on the fixed plate at positions corresponding to the spacers; and movable-side blocks which are formed on the movable plate so as to be paired with the respective fixed-side blocks, wherein after the spacers are placed on the respective fixed-side blocks, the movable plate is moved in such a direction as to engage the spacers, thereby holding the spacers fixed between the respective fixed-side blocks and movable-side blocks.

Preferably, in the spacer mounting mechanism according to the first aspect of the present invention, a thumbscrew is attached to the movable plate, and the spacers are held into position or released therefrom in a collective manner by turning the thumbscrew through a prescribed angle.

According to a second aspect of the present invention, there is provided a spacer mounting mechanism for mounting spacers to a product plate, comprising a fixed plate; fixed-side blocks which are formed on the fixed plate at positions corresponding to the spacers; and a movable-side block which is movable in an arbitrary direction, and which includes at least one frame member that faces the fixed-side blocks, wherein after the spacers are placed on the respective fixed-side blocks, the movable-side block is moved in such a direction as to engage the spacers, thereby holding the spacers fixed between the frame member and the respective fixed-side blocks.

Preferably, in the spacer mounting mechanism according to the second aspect of the present invention, a thumbscrew is attached to the movable-side block, and the spacers are held in position or released therefrom in a collective manner by turning the thumbscrew through a prescribed angle.

According to the present invention, there is also provided a method for fabricating a component having spacers, comprising the steps of placing the spacers on prescribed portions of a fixed-side block that is fixed in an arbitrary position; holding the spacers fixed between the fixed-side block and a movable-side block movable relative to the fixed-side block, in a collective manner by moving the movable-side block in such a direction as to engage the spacers; with the spacers held fixed in position, mounting the product plate in a prescribed position on the spacers; and moving the movable-side block in such a direction as to disengage from the spacers, thereby releasing the spacers from fixed positions in a collective manner, and separating the component having the spacers from the movable-side block and the fixed-side block.

To summarize, in the first aspect of the present invention, the plurality of spacers are respectively placed on prescribed portions (for example, spacer holding grooves) of the plurality of fixed-side blocks formed on the fixed plate, and the movable plate on which the plurality of movable-side blocks are formed is moved in a given direction, thereby holding the plurality of spacers fixed between the respective fixed-side blocks and movable-side blocks in a collective manner. With the spacers held fixed between the respective fixed-side blocks and movable-side blocks, the product plate is placed on the plurality of spacers, which are then mounted to the product plate with mounting screws or the like in a series of continuous operations, and after the spacer mounting job is completed, the movable plate is moved in the opposite direction, thereby releasing the spacers from fixed positions in a collective manner.

As a result, according to the first aspect of the present invention, as the action of holding the plurality of spacers between the respective fixed-side blocks and movable-side blocks and the action of tightening the plurality of mounting screws, etc., can be performed separately from each other, the need for a two-hand job as required in the prior art method can be eliminated, and the spacer mounting job can thus be simplified. Furthermore, as the action of tightening the plurality of mounting screws, etc., can be performed continuously by collectively holding the plurality of spacers in position, the number of times of exchanging tools such as screwdrivers is greatly reduced, eliminating time-consuming actions. In this way, the spacer mounting job can be accomplished efficiently and in a short time.

In the second aspect of the present invention, rather than using the plurality of movable-side blocks formed on the movable plate as in the first aspect, the movable-side block formed in a frame-like structure having a supporting frame member is moved in a given direction, thereby holding the plurality of spacers fixed between the frame member of the movable-side block and the fixed-side blocks in a collective manner, and after the spacer mounting job is completed, the movable-side block of the frame-like structure is moved in the opposite direction, thereby releasing the spacers from fixed positions in a collective manner.

As a result, according to the second aspect of the present invention, the spacer mounting job can be simplified because, as in the first aspect, the action of holding the plurality of spacers between the fixed-side blocks and the movable-side block of the frame-like structure and the action of tightening the plurality of mounting screws, etc., can be performed separately from each other. Furthermore, as the action of tightening the plurality of mounting screws, etc., can be performed continuously by collectively holding the plurality of spacers in position, the number of times of exchanging tools such as screwdrivers is greatly reduced. In this way, the spacer mounting job can be accomplished efficiently and in a short time. In the second aspect, the movable block of the frame-like structure having a supporting frame member is fabricated, and the movable block of the frame-like structure thus fabricated has greater rigidity than the plurality of movable-side blocks individually formed on the movable plate as in the foregoing first mode. As a result, in the second aspect, the spacer mounting error that can occur when mounting the spacer between the fixed-side block and the movable block can be reduced compared with the foregoing first aspect. Therefore, in the second aspect, the spacer mounting accuracy increases compared with the first aspect.

### BRIEF DESCRIPTION OF THE DRAWINGS

The above object and features of the present invention will be more apparent from the following description of some preferred embodiments with reference to the accompanying drawings, wherein:

FIG. 1 is a perspective view showing a procedure for mounting spacers to a product plate in accordance with a prior art method;

FIG. 2 is a perspective view showing the overall configuration of a spacer mounting mechanism according to a first embodiment of the present invention;

FIG. 3 is a plan view showing the spacers held on the spacer mounting mechanism according to the first embodiment of the present invention;

FIG. 4 is a plan view showing the spacers set in released position on the spacer mounting mechanism according to the first embodiment of the present invention;

FIG. 5 is a perspective view showing in enlarged form the essential parts of the spacer mounting mechanism according to the first embodiment of the present invention;

FIG. 6 is a flow diagram (part 1) for explaining the process of mounting the spacers to a product plate by using the spacer mounting mechanism according to the present invention;

FIG. 7 is a flow diagram (part 2) for explaining the process of mounting the spacers to a product plate by using the spacer mounting mechanism according to the present invention;

FIG. 8 is a plan view showing the spacers held on a spacer mounting mechanism according to a second embodiment of the present invention;

FIG. 9 is a plan view showing the spacers set in released position on the spacer mounting mechanism according to the second embodiment of the present invention;

FIG. 10 is a plan view showing a modified example of the spacer mounting mechanism according to the embodiment of FIG. 8;

FIG. 11 is a perspective view showing in enlarged form the portion of a modified fixed-side block of FIG. 10;

FIG. 12 is a plan view showing the spacers held on a spacer mounting mechanism according to a third embodiment of the present invention;

FIG. 13 is a plan view showing the spacers set in released position on the spacer mounting mechanism according to the third embodiment of the present invention.

### DESCRIPTION OF THE PREFERRED EMBODIMENTS

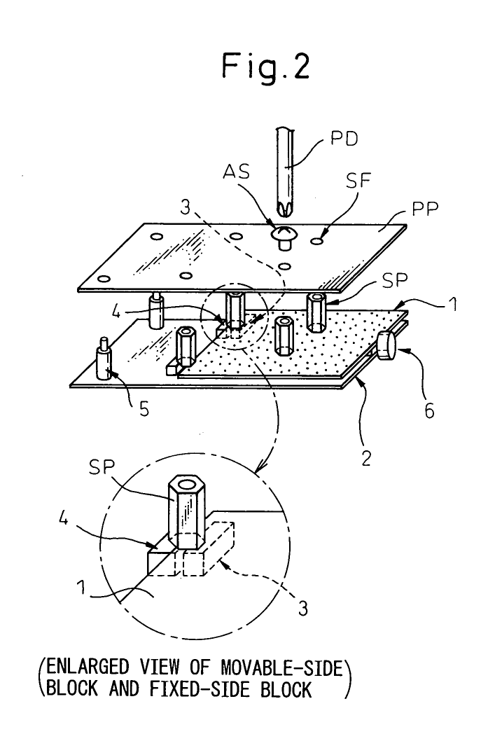

The configuration, operation, and other features of some preferred embodiments of the present invention will be described below with reference to the accompanying drawings (FIGS. 2 to 13).

FIG. 2 is a perspective view showing the overall configuration of a spacer mounting mechanism according to a first embodiment of the present invention. Hereinafter, component parts identical or similar to the earlier described parts will be designated by the same reference numerals.

As shown in FIG. 2, the spacer mounting mechanism according to the first embodiment of the present invention comprises a fixed plate 2 which is fixed in an arbitrary position when mounting a plurality of spacers SP to a product plate; a movable plate 1 which is movable relative to the fixed plate 2; fixed-side blocks 4 which are formed on the fixed plate 2 at positions corresponding to the spacers SP; and movable-side blocks 3 which are formed on the movable plate 1 so as to be paired with the respective fixed-side blocks 4.

Usually, when assembling a stack structure of a plurality of product plates PP (only one product plate is shown in FIG. 2) comprising printed board units, electronic appliance units, or the like, a plurality of polygonal spacers SP are mounted to each product plate so that the plurality of product plates can be installed by maintaining proper spacing from each other. FIG. 2 shows how the plurality of polygonal (hexagonal) spacers SP are mounted to one product plate PP by using the spacer mounting mechanism according to the first embodiment of the present invention.

A “component (i.e., plate-like component) having spacers” is fabricated by mounting the plurality of polygonal spacers SP to one product plate PP by using the spacer mounting mechanism according to the first embodiment of FIG. 2. When the fabrication of the component having spacers is completed, the spacer mounting mechanism according to the first embodiment of FIG. 2 is detached from the component having spacers. In other words, the spacer mounting mechanism of FIG. 2 is used only when mounting a plurality of spacers to a product plate, and is usually called a “jig” or “component mounting jig.” By sequentially stacking a plurality of such components having spacers, a stack structure of a plurality of product plates can be assembled.

The spacer mounting mechanism according to the first embodiment of FIG. 2 includes the fixed plate 2 fixed in a predetermined position and the movable plate 1 disposed in the vicinity of the fixed plate 2 and movable relative to the fixed plate 2 in such a direction as to engage or disengage from the plurality of spacers SP. Positioning pins 5 for positioning the product plate PP are formed on the fixed plate 2. The mounting mechanism further includes the plurality of fixed-side blocks 4, which are individually fixed to the fixed plate 2 by screws or the like at positions corresponding to the plurality of spacers SP, and the plurality of movable-side blocks 3, which are individually fixed to the movable plate 1 so as to be paired with the respective fixed-side blocks 4.

Further, in the spacer mounting mechanism of FIG. 2, a movable-side slide mechanism 6 including a thumbscrew or the like is attached to the movable-side blocks 3 or the movable plate 1. The movable-side slide mechanism 6 is operated to move the movable-side blocks 3 toward or away from the fixed-side blocks 4. By turning the thumbscrew of the movable-side slide mechanism 6 through a prescribed angle (for example, about 90 degrees), thus causing the movable plate 1 to slide (move) in such a direction as to engage or disengage from the plurality of spacers SP, the plurality of spacers SP can collectively be held in position or released therefrom. The lower part of FIG. 2 shows an enlarged view of the fixed-side block 4 and the movable-side block 3. The enlarged view shows how the spacer SP is held between the fixed-side block 4 and the movable-side block 3.

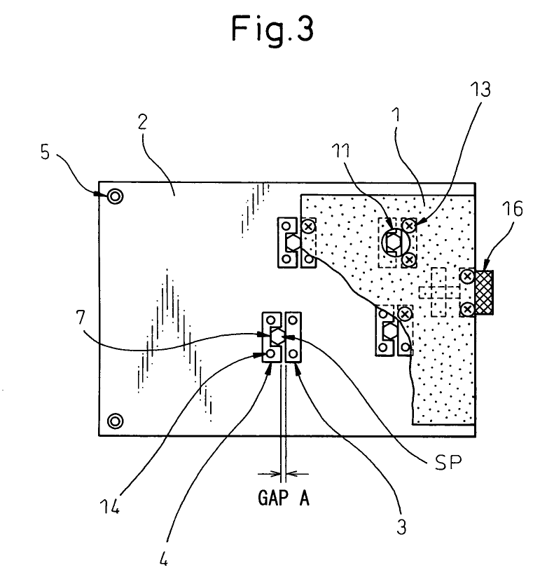

When mounting the plurality of spacers SP to the product plate PP by using the spacer mounting mechanism of FIG. 2, first the spacers SP are placed in spacer holding grooves (see FIGS. 3 to 5 that will be described later) formed in the respective fixed-side blocks 4.

Next, the thumbscrew of the movable-side slide mechanism 6 is turned in a given direction, causing the movable plate 1 with the movable-side blocks 3 fixed thereon to slide in such a direction as to engage the spacers SP, thereby holding the spacers SP in a collective manner between the respective fixed-side blocks 4 and movable-side blocks 3.

With the plurality of spacers SP securely held in position, the product plate PP is placed onto the spacers SP, and a mounting screw AS is fitted onto the Phillips screwdriver PD. The mounting screw AS fitted on the Phillips screwdriver PD is inserted in the hole of the spacer mounting portion SF formed in the product plate PP, and the mounting screw AS is tightened with a specified torque. Since the plurality of spacers SP are held in a collective manner between the respective fixed-side blocks 4 and movable-side blocks 3, the mounting screws AS are sequentially tightened into the respective spacers SP.

When all the spacers SP have been mounted to the product plate PP, the thumbscrew of the movable-side slide mechanism 6 is turned in the opposite direction, causing the movable plate 1 to slide in such a direction as to disengage from the spacers SP, thereby releasing the spacers SP from fixed positions. In this way, the product plate PP with the plurality of spacers SP mounted thereto (i.e., the component having spacers) is separated from the jig, completing the job of mounting the plurality of spacers SP to the product plate PP.

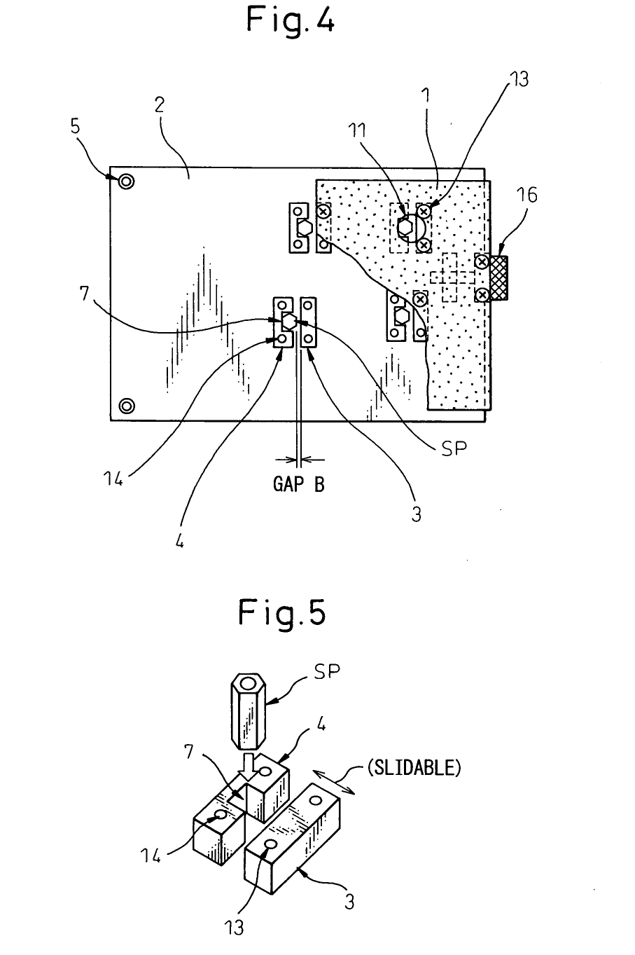

FIG. 3 is a plan view showing the spacers held on the spacer mounting mechanism according to the first embodiment of the present invention; FIG. 4 is a plan view showing the spacers set in released position on the spacer mounting mechanism according to the first embodiment; and FIG. 5 is a perspective view showing in enlarged form the essential parts of the spacer mounting mechanism according to the first embodiment.

In the spacer mounting mechanism shown in FIGS. 3 and 4, the positioning pins 5 are formed as shown in FIG. 2, and the fixed plate 2 fixed in a predetermined position and the movable plate 1 disposed in the vicinity of the fixed plate 2 are arranged as shown. Further, the plurality of fixed-side blocks 4 are individually fixed to the fixed plate 2 by screws 14, while the plurality of movable-side blocks 3 are individually fixed to the movable plate 1 by screws 13 so as to be paired with the respective fixed-side blocks 4. Each of the plurality of fixed-side blocks 4 is formed with a spacer holding groove 7, and the movable plate 1 is formed with holes 11 for passing the plurality of spacers SP therethrough.

Further, in the spacer mounting mechanism shown in FIGS. 3 and 4, the thumbscrew 16 is attached to the movable plate 1. By turning the thumbscrew 16 through a prescribed angle (for example, about 90 degrees), thus causing the movable plate 1 to slide in such a direction as to engage the plurality of spacers SP, the plurality of spacers SP can be held in position in a collective manner, as shown in the spacer mounting mechanism of FIG. 3. On the other hand, by turning the thumbscrew 16 through a prescribed angle (for example, about 90 degrees) in the direction opposite to that shown in FIG. 3, thus causing the movable plate 1 to slide in such a direction as to disengage from the plurality of spacers SP, the plurality of spacers SP can be released from fixed positions in a collective manner, as shown in the spacer mounting mechanism of FIG. 4.

When mounting the plurality of spacers SP to the product plate PP (see FIG. 2) by using the spacer mounting mechanism shown in FIGS. 3 and 4, first the spacers SP are inserted through the plurality of holes 11 formed in the movable plate 1, and placed in the spacer holding grooves 7 formed in the respective fixed-side blocks 4, as in the earlier described case of FIG. 2.

Next, the thumbscrew 16 is turned in a given direction, causing the movable plate 1 to slide in such a direction as to engage the spacers SP, thereby holding the plurality of spacers SP into the respective spacer holding grooves 7 of the fixed-side blocks 4 in a collective manner.

With the plurality of spacers SP thus held in the respective spacer holding grooves 7, the product plate PP (see FIG. 2) is placed onto the spacers SP, and the mounting screws AS (see FIG. 2) are set thereon and tightened with a specified torque. When all the spacers SP have been mounted to the product plate PP by the mounting screws AS, the thumbscrew 16 is turned in the opposite direction, causing the movable plate 1 to slide in such a direction as to disengage from the spacers SP, thereby releasing the spacers SP from fixed positions.

As shown in FIG. 3, when the plurality of spacers SP are collectively held in position, a gap A (first gap) is maintained between each fixed-side block 4 and its mating movable-side block 3 to prevent the fixed-side block 4 from directly contacting the movable-side block 3. The reason is that, if the fixed-side block 4 directly contacts the movable-side block 3, the spacer SP cannot be securely locked into position by the fixed-side block 4 and the movable-side block 3. Preferably, the gap A is set at about 0.5 mm.

On the other hand, as shown in FIG. 4, when placing the plurality of spacers SP in the respective spacer holding grooves 7 of the fixed-side blocks 4, first the movable plate 1 must be set into disengaged position, and then the spacers SP must be inserted in the respective spacer holding grooves 7 of the fixed-side blocks 4 through the holes 11 formed in the movable plate 1. For this purpose, a gap B (second gap) is provided between the holding position of each spacer SP and the corresponding movable-side block 3. The gap B need only be formed so as to provide spacing just enough to allow the spacer SP to be inserted in the spacer holding groove 7. Further, from the standpoint of reducing man-hours, the distance over which the movable plate 1 is caused to slide in such a direction as to engage the spacers SP after the spacers SP have been inserted into the spacer holding grooves 7 should be made as short as possible in order to minimize the time required to mount the spacers SP to the product plate PP. Preferably, the gap B is set at about 0.1 mm.

As shown in FIG. 5, the spacer holding groove 7 into which the polygonal spacer (in the illustrated example, the hexagonal spacer) SP is inserted is formed in the fixed-side block 4 which is fixed to the fixed plate by the screws 14. Therefore, the fixed-side block 4 is U-shaped. On the other hand, the movable-side block 3 is fixed to the movable plate by the screws 13, and can be moved in sliding fashion in such a direction as to engage or disengage from the spacer SP as the movable plate is caused to slide.

Here, the width of the spacer holding groove 7 shown in FIG. 5 is set equal to the diagonal (the longest diagonal) of the hexagonal spacer in order to ensure that the hexagonal spacer SP is securely fitted into the spacer holding groove 7. On the other hand, the depth of the spacer holding groove 7 in the plane direction is set slightly smaller than the distance between two opposing sides of the hexagonal spacer. When the depth of the spacer holding groove 7 in the plane direction is thus set, the gap A described with reference to FIG. 3 is created when the hexagonal spacer SP is held into position between the fixed-side block 4 and the movable-side block 3 by sliding the movable-side block 3 in such a direction as to engage the hexagonal spacer SP.

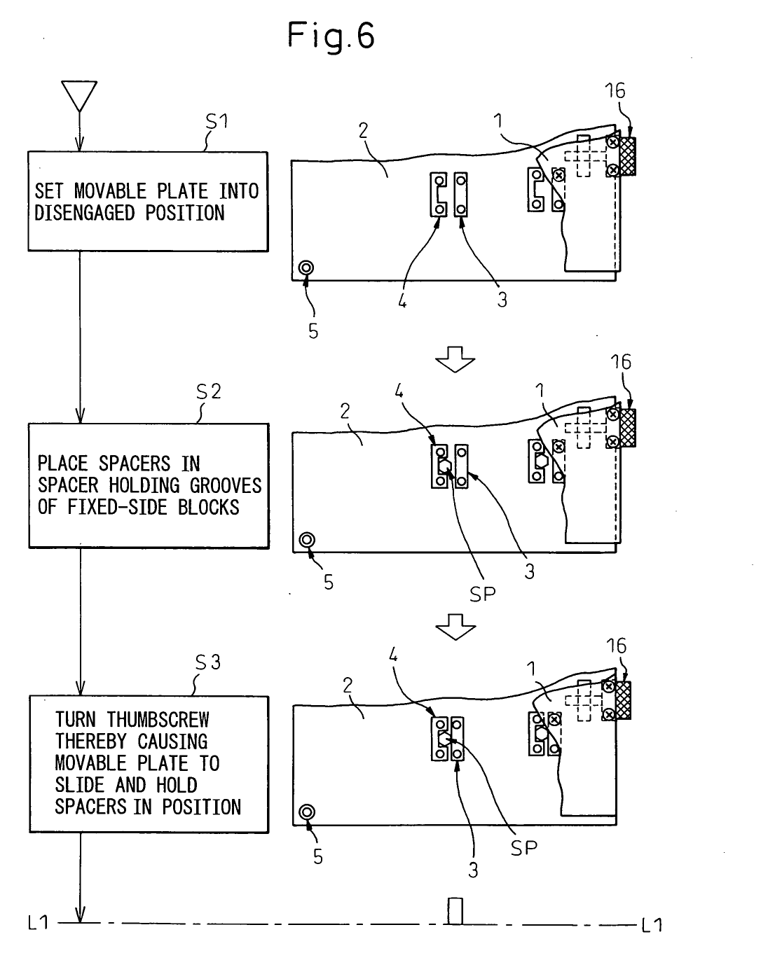

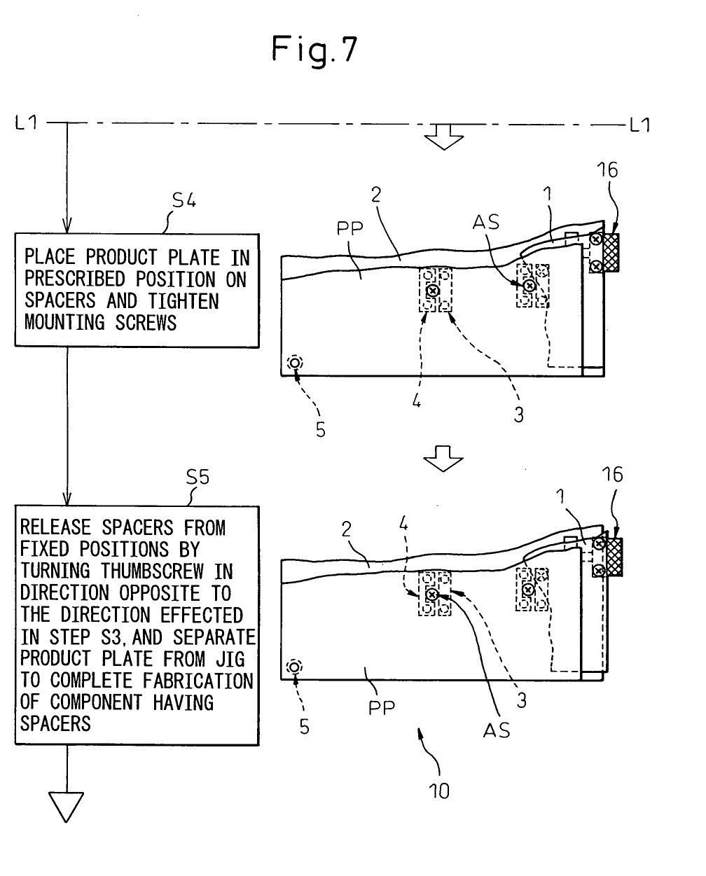

FIGS. 6 and 7 are flow diagrams, part 1 and part 2, for explaining the process of mounting the spacers to the product plate by using the spacer mounting mechanism according to the present invention. The following describes a series of steps for fabricating the component having spacers by mounting the plurality of spacers SP to the product plate PP using the spacer mounting mechanism according to the first embodiment shown in FIGS. 2 to 4. Here, the fixed plate 2 is fixed in a predetermined position, and the movable plate 1 is disposed in the vicinity of the fixed plate 2 and is movable in such a direction as to engage or disengage from the plurality of spacers SP.

When mounting the plurality of spacers SP to the product plate PP, first in step S1 of FIG. 6, the movable plate 1 is set into disengaged position by operating the thumbscrew 16, to create a gap B (see FIG. 4) between the fixed-side block 4 and the movable-side block 3.

Next, in step S2 of FIG. 6, the plurality of spacers SP are placed in the respective spacer holding grooves by inserting the plurality of spacers SP into the spacer holding grooves formed in the respective fixed-side blocks 4.

Further, in step S3 of FIG. 6, the thumbscrew 16 is turned in a given direction, causing the movable plate 1 to slide in such a direction as to engage the plurality of spacers SP, thereby holding the plurality of spacers SP in a collective manner between the respective fixed-side blocks 4 and movable-side blocks 3.

Then, in step S4 of FIG. 7, with all the spacers SP thus held in position, the product plate PP is placed in a prescribed position on the plurality of spacers SP, and the mounting screws AS are set thereon and tightened with a specified torque.

Further, in step S5 of FIG. 7, after all the spacers SP have been mounted to the product plate PP by the plurality of mounting screws AS, the thumbscrew 16 is turned in the opposite direction, causing the movable plate 1 to slide in such a direction as to disengage from the plurality of spacers SP, thus releasing the spacers SP from fixed positions. In this condition, the jig is detached from the product plate PP. In this way, the product plate PP with the plurality of spacers SP mounted thereon is separated from the jig, completing the fabrication of the component 10 having spacers.

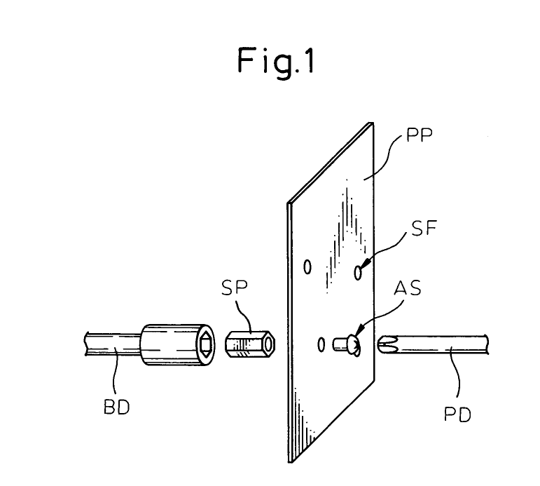

In the thus completed component 10 having spacers, since the mounting screws are tightened with the plurality of spacers held fixed in position as described above, all the hexagonal spacers are oriented in the same direction. On the other hand, when the plurality of spacers are mounted to the product plate in accordance with the prior art method (see FIG. 1), the plurality of hexagonal spacers are randomly oriented. Accordingly, the appearance of the component having spacers shown in FIG. 7 is aesthetically pleasing compared with the appearance of the component fabricated in accordance with the prior art method.

According to the first embodiment of the present invention, as the action of holding the plurality of spacers by the fixed-side blocks and movable-side blocks and the action of tightening the plurality of mounting screws can be performed separately from each other, the process of mounting the plurality of spacers to the product plate can be simplified. Furthermore, as the plurality of spacers are held fixed in position in a collective manner, the action of tightening the mounting screws can be performed continuously, which serves to greatly reduce the number of times of exchanging tools such as screwdrivers. In this way, the spacer mounting job can be accomplished efficiently and in a short time.

Table 1 below shows a comparison of the spacer mounting time (in minutes) required to mount the plurality of spacers to the product plate between the case in which the spacers are mounted using the spacer mounting mechanism according to the present invention (for example, the spacer mounting mechanism according to the first embodiment of the present invention) and the case in which the spacers are mounted in accordance with the prior art method.

TABLE 1
Comparison of spacer mounting times

Number of
spacers

| | 7 | 9 |
|---|---|---|
| Prior art method | 2.3 min. | 3.1 min. |
| Present invention | 0.5 min. | 0.6 min. |
| Difference | 1.8 min. | 2.5 min. |

More specifically, Table 1 shows the results of the measurements of the spacer mounting time required to mount seven spacers to the product plate and the results of the measurements of the spacer mounting time required to mount nine spacers to the product plate. As is apparent from the comparison of the spacer mounting times shown in Table 1, when the spacers are mounted using the spacer mounting mechanism according to the present invention, the spacer mounting time required to mount the seven spacers to the product plate is shortened by 1.8 minutes compared with the case in which the spacers are mounted in accordance with the prior art method, and the spacer mounting time required to mount the nine spacers to the product plate is shortened by 2.5 minutes. It has thus been verified that when the spacer mounting mechanism according to the present invention is used to mount the spacers to the product plate, there is offered an advantageous effect such as being able to accomplish the spacer mounting job efficiently and in a short time.

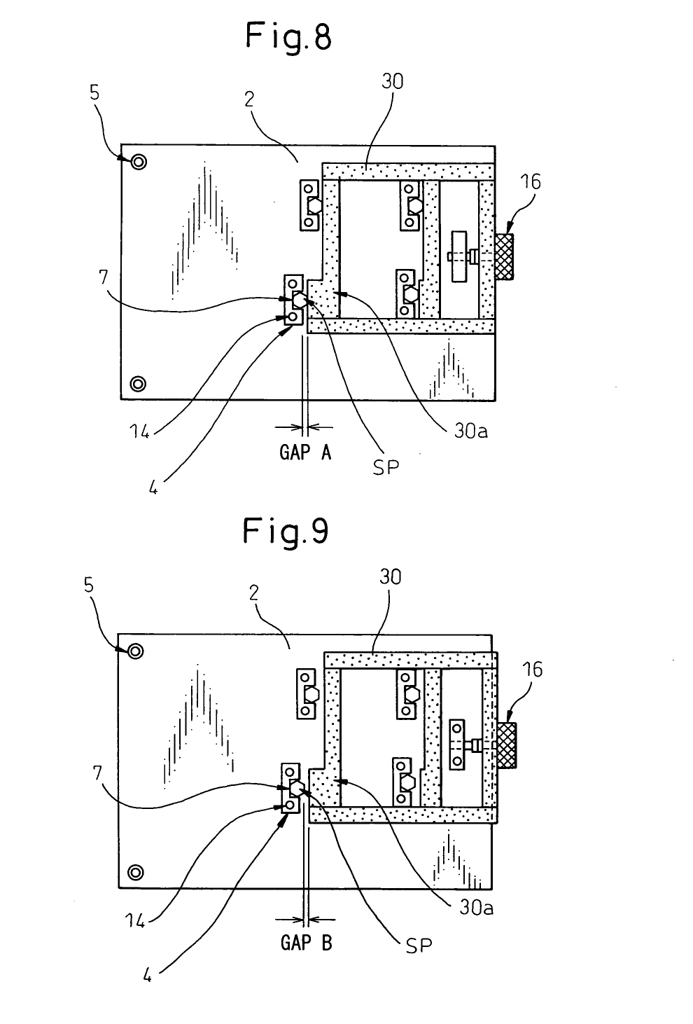

FIG. 8 is a plan view showing the spacers held on the spacer mounting mechanism according to a second embodiment of the present invention, and FIG. 9 is a plan view showing the spacers set in released position on the spacer mounting mechanism according to the second embodiment.

In the spacer mounting mechanism shown in FIGS. 8 and 9, a frame-shaped movable block 30 having a plurality of supporting frame members 30a is used, rather than using the plurality of movable-side blocks formed on the movable plate as in the first embodiment described above. The spacer mounting mechanism according to the second embodiment is constructed so that the frame-shaped movable block 30 is moved in a given direction to hold the plurality of spacers SP fixed in a collective manner between the fixed-side blocks 4 and the frame members 30a of the frame-shaped movable block and, after the spacer mounting job is completed, the frame-shaped movable block is moved in the opposite direction to release the spacers SP from the fixed positions in a collective manner.

More specifically, in the spacer mounting mechanism shown in FIGS. 8 and 9, positioning pins 5 are formed on the fixed plate 2 which is fixed in a predetermined position. Further, the fixed-side blocks 4 are individually fixed to the fixed plate 2 by screws 14, and the frame-shaped movable block 30 is provided with the plurality of frame members 30a that are disposed so as to face the plurality of fixed-side blocks 4. The spacer holding groove 7 is formed in each of the fixed-side blocks 4, as in the foregoing first embodiment.

Further, in the spacer mounting mechanism shown in FIGS. 8 and 9, the thumbscrew 16 is attached to the frame-shaped movable block 30. By turning the thumbscrew 16 through a prescribed angle (for example, about 90 degrees), thus causing the frame-shaped movable block 30 to slide in such a direction as to engage the plurality of spacers SP, the plurality of spacers SP can be held in position in a collective manner, as shown in the spacer mounting mechanism of FIG. 8. On the other hand, by turning the thumbscrew 16 through a prescribed angle (for example, about 90 degrees) in the direction opposite to that shown in FIG. 8, thus causing the frame-shaped movable block 30 to slide in such a direction as to disengage from the plurality of spacers SP, the plurality of spacers SP can be released from fixed positions in a collective manner, as shown in the spacer mounting mechanism of FIG. 9.

When mounting the plurality of spacers SP to the product plate PP (see FIG. 2) by using the spacer mounting mechanism shown in FIGS. 8 and 9, first the spacers SP are placed in the spacer holding grooves 7 formed in the respective fixed-side blocks 4. In this case, unlike the case of the first embodiment, there is no need to form holes in the frame-shaped movable block 30 for passing the plurality of spacers SP therethrough, since the frame-shaped movable block 30 is constructed using the supporting frame members 30a. The frame-shaped movable block 30 thus constructed has an advantage in that the holding condition of the spacers SP can be visually checked after the spacers SP have been placed in the spacer holding grooves 7.

Next, the thumbscrew 16 is turned in a given direction, causing the frame-shaped movable block 30 to slide in such a direction as to engage the spacers SP, thereby holding the plurality of spacers SP in a collective manner between the fixed-side blocks 4 and the frame members 30a of the frame-shaped movable block 30.

With the plurality of spacers SP thus held in the respective spacer holding grooves 7, the product plate (for example, see FIG. 2) is placed onto the plurality of spacers SP, and the mounting screws (see FIG. 2) are set thereon and tightened with a specified torque. When all the spacers SP have been mounted to the product plate by the mounting screws, the thumbscrew 16 is turned in the opposite direction, causing the frame-shaped movable block 30 to slide in such a direction as to disengage from the spacers SP, thereby releasing the spacers SP from fixed positions.

As shown in FIG. 8, when the plurality of spacers SP are collectively held in position, a gap A (first gap) is maintained between each fixed-side block 4 and its mating frame member 30a of the frame-shaped movable block 30, as in the first embodiment, in order to prevent the fixed-side block 4 from directly contacting the frame member 30a of the frame-shaped movable block 30. In this case also, the gap A is set at about 0.5 mm.

On the other hand, as shown in FIG. 9, when placing the plurality of spacers SP in the respective spacer holding grooves 7 of the fixed-side blocks 4, first the frame-shaped movable block 30 must be set into disengaged position, and then the plurality of spacers SP must be inserted in the respective spacer holding grooves 7 formed in the fixed-side blocks 4. For this purpose, a gap B (second gap) is provided between the holding position of each spacer SP and the corresponding frame member 30a of the frame-shaped movable block 30. As in the first embodiment, the gap B need only be formed so as to provide slight spacing just enough to allow the spacer SP to be inserted in the spacer holding groove 7. In this case also, the gap B is set at about 0.1 mm.

According to the second embodiment of the present invention, since the job of holding the plurality of spacers by the fixed-side blocks and frame-shaped movable block and the job of tightening the plurality of mounting screws can be performed separately from each other, as in the foregoing first embodiment, the process of mounting the plurality of spacers to the product plate can be simplified. Furthermore, since the plurality of spacers are held fixed in position in a collective manner, the action of tightening the mounting screws can be performed continuously, which serves to greatly reduce the number of times of exchanging tools such as screwdrivers. In this way, the spacer mounting job can be accomplished efficiently and in a short time.

Furthermore, according to the second embodiment of the present invention, the frame-shaped movable block is fabricated using frame members, and the frame-shaped movable block thus fabricated has greater rigidity than the plurality of movable-side blocks individually formed on the movable plate as in the foregoing first embodiment. As a result, in the second embodiment, the spacer mounting error that can occur when mounting the spacer between the fixed-side block and the frame member of the frame-shaped movable block can be reduced compared with the foregoing first embodiment. Therefore, in the second embodiment, the spacer mounting accuracy is increased compared with the first embodiment.

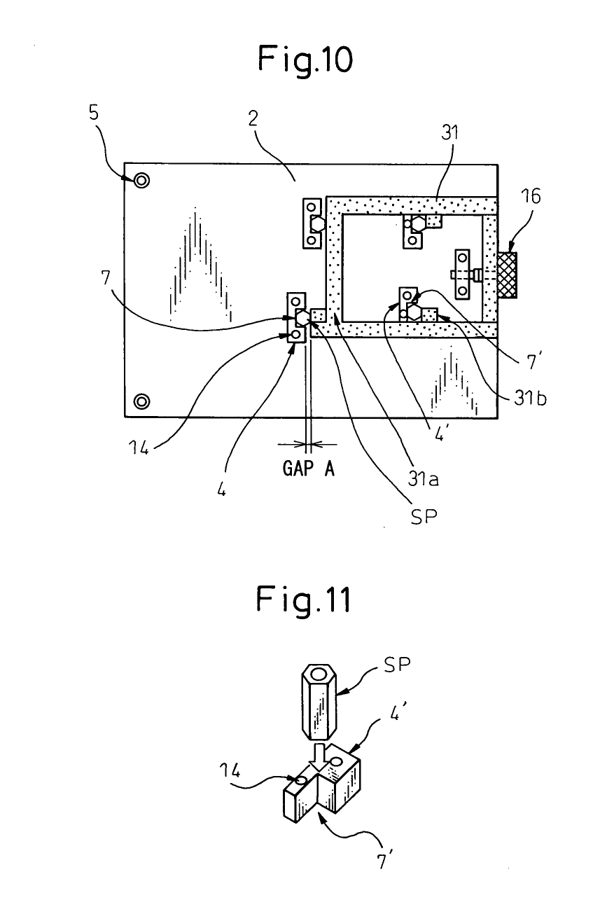

FIG. 10 is a plan view showing a modified example of the spacer mounting mechanism according to the embodiment of FIG. 8, and FIG. 11 is a perspective view showing in enlarged form the portion of the modified fixed-side block of FIG. 10.

The spacer mounting mechanism shown in FIG. 10 is substantially the same as the spacer mounting mechanism of the second embodiment shown in FIG. 8, but differs from the spacer mounting mechanism of the second embodiment in the following two points.

The first point is that, in the spacer mounting mechanism shown in FIG. 10, protrusions 31b, each constructed from a small protruding block, are formed instead of the frame members 30a at designated positions on the modified frame-shaped movable block 31. Such protrusions 31b are formed in order to save the cost required to form the frame members of the frame-shaped movable block in the shape of supporting frame members.

The second point is that, in the spacer mounting mechanism shown in FIG. 10, some of the fixed-side blocks are formed as modified fixed-side blocks 4′ which are made one-half as wide as the fixed-side blocks 4 of the second embodiment shown in FIG. 8 to match the size of the protrusions 31b. In each of such modified fixed-side blocks 4′, a spacer holding recess 7′ is formed instead of the spacer holding groove 7, as shown in the enlarged perspective view of FIG. 11, and thus each modified fixed-side block 4′ has an L-shaped form.

In other words, in the spacer mounting mechanism shown in FIG. 10, the frame-shaped movable block 30 in the second embodiment of FIG. 8 is replaced by the modified frame-shaped movable block 31 which comprises the frame members 30a that face some of the fixed-side blocks 4 and the protrusions 31b that face the remaining modified fixed-side blocks 4′.

The process of mounting the plurality of spacers SP to the product plate PP (see FIG. 2) using the spacer mounting mechanism of FIG. 10 is substantially the same as that of the second embodiment previously described with reference to FIG. 8, and therefore, the description will not be repeated here.

According to the modified example of FIG. 10, since the action of holding the plurality of spacers by the fixed-side blocks and modified frame-shaped movable block and the action of tightening the plurality of mounting screws can be performed separately from each other, as in the foregoing second embodiment, the process of mounting the plurality of spacers to the product plate can be simplified. Furthermore, since the plurality of spacers are held fixed in position in a collective manner, the action of tightening the mounting screws can be performed continuously, which serves to greatly reduce the number of times of exchanging tools such as screwdrivers. In this way, the spacer mounting job can be accomplished efficiently and in a short time.

Furthermore, according to the modified example of FIG. 10, since the cost for forming the frame members of the frame-shaped movable block in the shape of supporting frame members can be saved, the cost required to fabricate the spacer mounting mechanism is lower than in the foregoing second embodiment. However, the rigidity of the modified frame-shaped movable block which includes several protrusions is lower than the rigidity of the frame-shaped movable block having the supporting frame members, and it is therefore preferable to provide some means to address this deficiency.

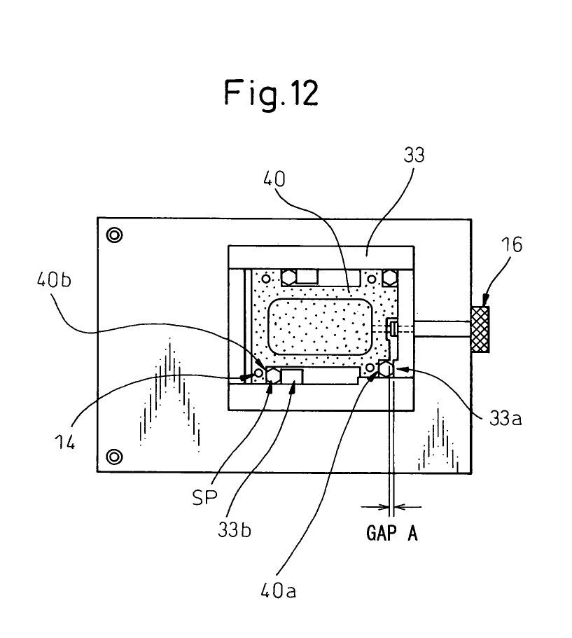

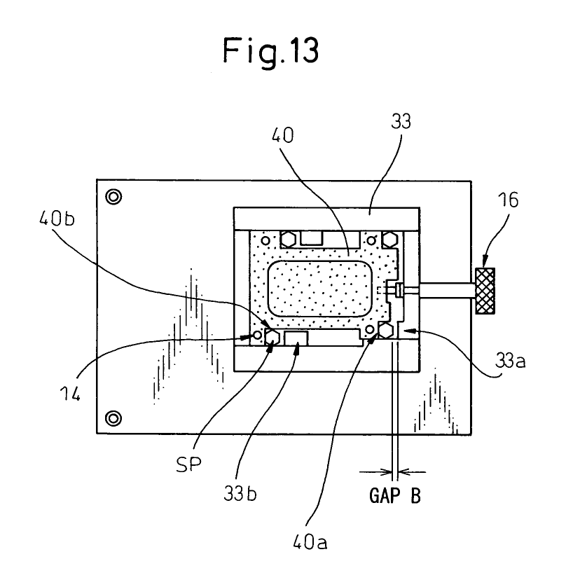

FIG. 12 is a plan view showing the spacers held on the spacer mounting mechanism according to a third embodiment of the present invention, and FIG. 13 is a plan view showing the spacers set in released position on the spacer mounting mechanism according to the third embodiment.

In the spacer mounting mechanism shown in FIGS. 12 and 13, the plurality of spacers SP are placed in designated positions (for example, in spacer holding recesses 40a and 40b) on an integrated fixed block 40 constructed by forming the fixed plate and fixed-side blocks into an integrated one-piece structure, and a modified frame-shaped movable block 33 is moved in a given direction to hold the plurality of spacers SP fixed in a collective manner between the integrated fixed block 40 and the frame members 33a or protrusions 33b of the modified frame-shaped movable block 33; when the spacer mounting job is completed, the modified frame-shaped movable block 33 is moved in the opposite direction to release the spacers SP from the fixed positions.

More specifically, in the spacer mounting mechanism shown in FIGS. 12 and 13, the integrated fixed block 40 is provided which is constructed by forming the fixed-side blocks, arranged on the fixed plate at positions corresponding to the plurality of spacers SP, integrally with the fixed plate which is fixed in a predetermined position. In implementing the process of mounting the plurality of spacers SP to the product plate PP (see FIG. 2), it is desirable to reduce the weight of the integrated fixed block 40 as much as possible. For this purpose, some of the portions other than the portions for holding the plurality of spacers SP (for example, the center portion of the integrated fixed block 40) are shaved off to reduce the weight of the integrated fixed block 40.

In the spacer mounting mechanism shown in FIGS. 12 and 13, the modified frame-shaped movable block 33 includes the plurality of supporting frame members 33a, each disposed facing the integrated fixed block 40, and the protrusions 33b each constructed from a small protruding block. The spacer holding recesses 40a and 40b for holding the plurality of spacers SP are formed by shaving off outside portions of the integrated fixed block 40.

Further, in the spacer mounting mechanism shown in FIGS. 12 and 13, the thumbscrew 16 is attached to the modified frame-shaped movable block 33. By turning the thumbscrew 16 through a prescribed angle (for example, about 90 degrees), thus causing the modified frame-shaped movable block 33 to slide in such a direction as to engage the plurality of spacers SP, the plurality of spacers SP can be held in position in a collective manner, as shown in the spacer mounting mechanism of FIG. 12. On the other hand, by turning the thumbscrew 16 through a prescribed angle (for example, about 90 degrees) in the direction opposite to that shown in FIG. 12, thus causing the modified frame-shaped movable block 33 to slide in such a direction as to disengage from the plurality of spacers SP, the plurality of spacers SP can be released from fixed positions in a collective manner, as shown in the spacer mounting mechanism of FIG. 13.

When mounting the plurality of spacers SP to the product plate PP (see FIG. 2) by using the spacer mounting mechanism shown in FIGS. 12 and 13, first the spacers SP are placed in the spacer holding recesses 40a and 40b formed in the integrated fixed block 40. In this case, unlike the case of the previously described first embodiment, there is no need to form holes in the modified frame-shaped movable block 33 for passing the plurality of spacers SP therethrough, since the modified frame-shaped movable block 33 is constructed using the supporting frame members 30a and protrusions 33b. As in the foregoing second embodiment, the modified frame-shaped movable block 33 thus constructed has the advantage that the holding condition of the spacers SP can be visually checked after the spacers SP have been placed in the spacer holding recesses 40a and 40b.

Next, the thumbscrew 16 is turned in a given direction, causing the modified frame-shaped movable block 33 to slide in such a direction as to engage the spacers SP, thereby holding the spacers SP in a collective manner between the integrated fixed block 40 and the frame members 33a or protrusions 33b of the modified frame-shaped movable block 33.

With the plurality of spacers SP thus held in the respective spacer holding recesses 40a and 40b, the product plate (for example, see FIG. 2) is placed onto the plurality of spacers SP, and the mounting screws (see FIG. 2) are set thereon and tightened with a specified torque. When all the spacers SP have been mounted to the product plate by the mounting screws, the thumbscrew 16 is turned in the opposite direction, causing the modified frame-shaped movable block 33 to slide in such a direction as to disengage from the spacers SP, thereby releasing the spacers SP from fixed positions.

As shown in FIG. 12, when the plurality of spacers SP are collectively held in position, a gap A (first gap) is maintained between the integrated fixed block 40 and its mating frame member 33a of the modified frame-shaped movable block 33, as in the first and second embodiments, in order to prevent the outside portion of the integrated fixed block 40 from directly contacting the frame member 33a of the modified frame-shaped movable block 33. In this case also, the gap A is set at about 0.5 mm.

On the other hand, as shown in FIG. 13, when placing the spacers SP in the spacer holding recesses 40a (or 40b) of the integrated fixed block 40, first the modified frame-shaped movable block 33 must be set into disengaged position, and then the plurality of spacers SP must be inserted in the spacer holding recesses 40a (or 40b) formed in the integrated fixed block 40. For this purpose, a gap B (second gap) is provided between the holding position of each spacer SP and the corresponding frame member 33a of the modified frame-shaped movable block 33. As in the first and second embodiments, the gap B need only be formed so as to provide slight spacing just enough to allow the spacer SP to be inserted in the spacer holding recess 40a (or 40b). In this case also, the gap B is set at about 0.1 mm.

According to the third embodiment of the present invention, since the action of holding the plurality of spacers by the integrated fixed block and modified frame-shaped movable block and the action of tightening the plurality of mounting screws can be performed separately from each other, as in the first and second embodiments, the process of mounting the plurality of spacers to the product plate can be simplified. Furthermore, as the plurality of spacers are held fixed in position in a collective manner, the action of tightening the mounting screws can be performed continuously, which serves to greatly reduce the number of times of exchanging tools such as screwdrivers. In this way, the spacer mounting job can be accomplished efficiently and in a short time.

Furthermore, according to the third embodiment of the present invention, the integrated fixed block is fabricated by forming a single base plate, and the integrated fixed block thus fabricated has greater rigidity than the plurality of fixed-side blocks individually fixed to the fixed plate as in the foregoing second embodiment. As a result, in the third embodiment, the spacer mounting error that can occur when mounting the spacer between the integrated fixed block and the frame member of the frame-shaped movable block can be further reduced compared with the foregoing second embodiment. Therefore, in the third embodiment, the spacer mounting accuracy is further increased compared with the second embodiment.

With regard to the field of industrial application of the present invention, the present invention is applicable for assembling a stack structure of a plurality of product plates, which is implemented by mounting a plurality of spacers to each product plate efficiently and in a short time while holding the spacers fixed in position in a collective manner in an electronic apparatus or a communication apparatus constructed by mounting a plurality of product plates, including printed board units, electronic appliance units, or the like, within an apparatus cabinet.

1. A spacer mounting mechanism for mounting spacers to a product plate, comprising:
a fixed plate;
a movable plate which is movable relative to said fixed plate;
fixed-side blocks which are formed on said fixed plate at positions corresponding to said spacers; and
movable-side blocks which are formed on said movable plate so as to be paired with said fixed-side blocks;
wherein after said spacers are placed on said fixed-side blocks, said movable plate is moved in such a direction as to engage said spacers, thereby holding said spacers fixed between said fixed-side blocks and said movable-side blocks.

2. A spacer mounting mechanism as claimed in claim 1, wherein when said spacers are held fixed between said fixed-side blocks and said movable-side blocks, a first gap is maintained between each of said fixed-side blocks and a corresponding one of said movable-side blocks.

3. A spacer mounting mechanism as claimed in claim 1, wherein when said spacers are placed on prescribed portions of said fixed-side blocks, a second gap is maintained between the position in which each of said spacers is placed and a corresponding one of said movable-side blocks.

4. A spacer mounting mechanism as claimed in claim 1, wherein a thumbscrew is attached to said movable plate, and said spacers are held in position or released therefrom in a collective manner by turning said thumbscrew through a prescribed angle.

5. A spacer mounting mechanism for mounting spacers to a product plate, comprising:
a fixed plate;
fixed-side blocks which are formed on said fixed plate at positions corresponding to said spacers; and
a movable-side block which is movable in an arbitrary direction, and which includes at least one frame member that faces said fixed-side blocks;
wherein after said spacers are placed on said fixed-side blocks, said movable-side block is moved in such a direction as to engage said spacers, thereby holding said spacers between said frame member and said fixed-side blocks.

6. A spacer mounting mechanism as claimed in claim 5, wherein when said spacers are held fixed between said frame member of said movable-side block and said fixed-side blocks, a first gap is maintained between each of said fixed-side blocks and said frame member of said movable-side block.

7. A spacer mounting mechanism as claimed in claim 5, wherein when said spacers are placed on prescribed portions of said fixed-side blocks, a second gap is maintained between the position in which each of said spacers is placed and said frame member of said movable-side block.

8. A spacer mounting mechanism as claimed in claim 5, wherein a thumbscrew is attached to said movable-side block, and said spacers are held in position or released therefrom in a collective manner by turning said thumbscrew through a prescribed angle.

9. A spacer mounting mechanism for mounting spacers to a product plate, comprising:
a fixed-side block which holds said spacers in position;
a movable-side block which is movable relative to said fixed-side block, and which holds said spacers in position in cooperation with said fixed-side block; and
a moving mechanism which moves said movable-side block in directions toward and away from said fixed-side block.

10. A component mounting jig for mounting components to be screwed to a product plate, comprising:
a fixed-side block which holds said components in position;
a movable-side block which is movable relative to said fixed-side block, and which holds said components in position in cooperation with said fixed-side block; and
a moving mechanism which moves said movable-side block in directions toward and away from said fixed-side block.

11. A method for fabricating a component having spacers, comprising the steps of:
placing said spacers on prescribed portions of a fixed-side block that is fixed in an arbitrary position;
holding said spacers fixed between said fixed-side block and a movable-side block movable relative to said fixed-side block, in a collective manner by moving said movable-side block in such a direction as to engage said spacers;
with said spacers held fixed in position, mounting said product plate in a prescribed position on said spacers; and
moving said movable-side block in such a direction as to disengage from said spacers, thereby releasing said spacers from fixed positions in a collective manner, and separating said component having said spacers from said movable-side block and said fixed-side block.

12. A method for fabricating a component having spacers, comprising the steps of:
placing said spacers on prescribed portions of a fixed-side block that is formed in an arbitrary position;
holding said spacers fixed between said fixed-side block and a movable-side block movable relative to said fixed-side block, in a collective manner by moving said movable-side block in a direction toward said fixed-side block;
with said spacers held fixed in position, mounting said product plate onto said spacers; and
moving said movable-side block in a direction away from said fixed-side block, thereby releasing said spacers from fixed positions in a collective manner, and separating said component having said spacers from said movable-side block and said fixed-side block.

13. A method for fabricating a plate-like member to which components to be fixed by screws are mounted, comprising the steps of:
placing said components on prescribed portions of a fixed-side block that is formed in an arbitrary position;
holding said components fixed between said fixed-side block and a movable-side block movable relative to said fixed-side block, in a collective manner by moving said movable-side block in a direction toward said fixed-side block;
with said components held fixed in position, mounting said plate-like member onto said components; and
with said components screwed to said plate-like member, moving said movable-side block in a direction away from said fixed-side block, thereby releasing said components from fixed positions in a collective manner.
